(19) United States
(12) Patent Application Publication
(10) Pub. No.: US 2010/0235346 A1
(43) Pub. Date: Sep. 16, 2010

(54) MULTI-TIERED SYSTEM FOR SEARCHING LARGE COLLECTIONS IN PARALLEL

(75) Inventors: Ricardo Baeza-Yates, Barcelona (ES); Vanessa Murdock, Barcelona (ES)

Correspondence Address: Weaver Austin Villeneuve & Sampson - Yahoo!, P.O. BOX 70250, OAKLAND, CA, 94612-0250, US

(73) Assignee: YAHOO! INC, Sunnyvale, CA (US)

(21) Appl. No.: 12/404,008

(22) Filed: Mar. 13, 2009

(51) Int. Cl. G06F 17/30

(52) U.S. Cl. 707/713; 707/E17.014; 707/E17.017

(57) ABSTRACT

The system includes a pre-retrieval predictor which determines which collection to submit the query to with a certain degree of confidence. The query is then submitted to either one collection, or multiple collections in parallel. When the results are returned, they are assessed and if they are deemed adequate they are shown to the user. If they are inadequate, the results from the smaller and larger collections are merged and shown to the user. Only if the predictor failed to send the query to more than one collection and the result is not adequate, the query is sent to other collections and executed in a sequential fashion. Overall, large scale searching can be accomplished much more efficiently with no degradation in the quality of the retrieved results and a small increase in processing cost.

### BACKGROUND OF THE INVENTION

This invention relates generally to search engines and queries.

The majority of previous work in query performance prediction is geared toward deciding which queries are difficult, with the idea that difficult queries might benefit from query expansion, spelling corrections, or suggestions posed to the user. Because they are intended to predict the ambiguity of the query, given the retrieval results, they are not suitable for the task of predicting which corpus to search. They are rather more suitable for assessing the quality of the search results

### SUMMARY OF THE INVENTION

Embodiments of the present invention improve upon serial systems by predicting when a query will not be answered well by a first corpus, and sending the query to at least one other corpus to be searched in parallel with the first corpus. An improved prediction mechanism enables a parallel search that results in more relevant search results in less time than prior serial systems.

One aspect relates to a computer-implemented method for providing search results. The method comprises providing a first corpus of searchable information, providing a second corpus of searchable information, receiving a search query, and performing a pre-retrieval prediction of the search query to determine whether the query is best handled by the searching the first corpus alone or by searching the first and second corpus in parallel, the pre-retrieval prediction comprising combining at least two search independent predictors in formulating the prediction.

In certain embodiments at least two combined search independent predictors are from a group of predictors comprising: average pointwise mutual information; maximum pointwise mutual information; averaged Chi-square; maximum Chi square; averaged term frequency; term frequency standard deviation; averaged IDF; IDF deviation; simplified CS; query scope; maximum query scope; average document length; and query length.

Another aspect relates to a computer system for providing search results to users. The system comprises a first corpus of searchable information at a first computer storage medium; a second corpus of searchable information at a second computer storage medium; a computer processor configured to make a pre-retrieval prediction of whether the query is best handled by searching the first corpus alone or by searching the first and second corpus in parallel. The pre-retrieval prediction comprises combining at least two search independent predictors in formulating the prediction, the predictors selected from the group comprising: average pointwise mutual information; maximum pointwise mutual information; averaged Chi-square; maximum Chi square; averaged term frequency; term frequency standard deviation; averaged IDF; IDF deviation; simplified CS; query scope; maximum query scope; average document length; and query length.

A further understanding of the nature and advantages of the present invention may be realized by reference to the remaining portions of the specification and the drawings.

### BRIEF DESCRIPTION OF THE DRAWINGS

FIG. 1 is a block diagram illustrating a parallel architecture according an embodiment of the present invention.

FIG. 2 is a flow chart of an embodiment of a search process.

FIG. 3 is a table of pre-retrieval features/predictors.

FIG. 4 is a simplified diagram of a computing environment in which embodiments of the invention may be implemented.

A further understanding of the nature and advantages of the present invention may be realized by reference to the remaining portions of the specification and the drawings.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention. All documents and literature referenced herein are hereby incorporated by reference in the entirety.

Embodiments utilize a pre-retrieval predictor to determine which collection(s) to submit the query to with a certain degree of confidence. The query is then submitted to either one collection, or multiple collections in parallel. When the results are returned, they are assessed and if they are deemed adequate they are shown to the user. If they are inadequate, the results from the smaller and larger collections are merged and shown to the user. Only if the predictor failed to send the query to more than one collection and the result is not adequate, the query is sent to other collections and executed in a sequential fashion. Overall, large scale searching can be accomplished much more efficiently with little or no degradation in the quality of the retrieved results and a small increase in processing cost.

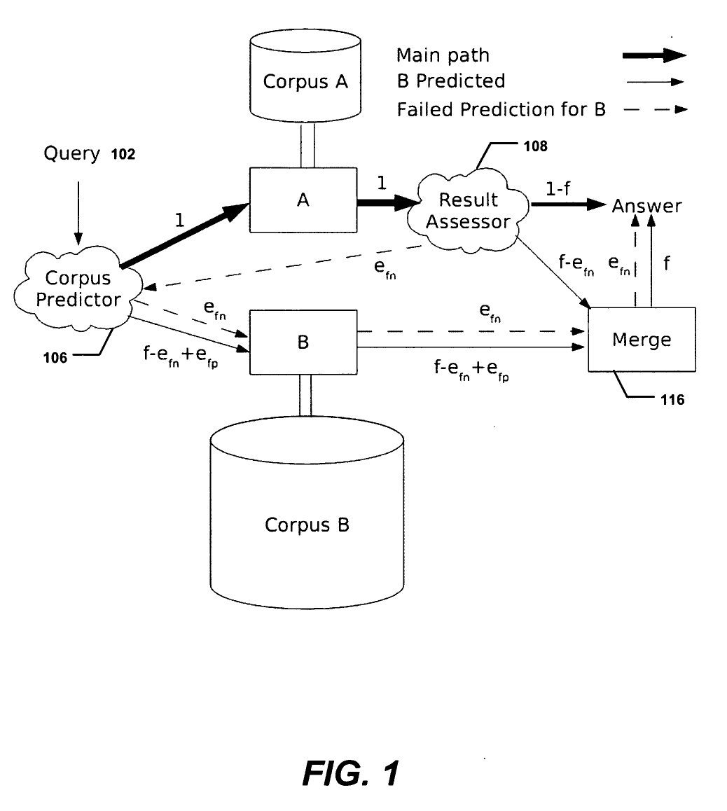

For the purpose of simplicity, two corpora are illustrated in FIG. 1, although in practice there could be many. FIG. 1 shows the basic architecture of the system. Query 102 is analyzed by corpus predictor 106. Corpus predictor 106 is implemented on one or more search configured/optimized computer systems each having one or more processors. In one embodiment, corpus A is smaller than corpus B, or nearer to the user (the system components and corpora may be in different geographic locations or centralized), and is faster to search, therefore by default the system will search corpus A of system A. In other embodiments, there may not be a default corpus. The system employs a predictor that indicates whether a query must also be served by another corpus or corpora, in this example corpus B, before any search results are returned. If the predictor predicts corpus B, then system/corpus B is searched in parallel with A. In one embodiment, the system also comprises results assessor 108, implemented on one or more search configured/optimized computers comprising one or more processors, that assesses the results and accuracy of the predictor. One way to assess the accuracy of the predictor is to evaluate whether the system returns a sufficient number of documents for a given query, as will be discussed in greater detail below.

In such an embodiment, if the predictor is wrong, and the results from A were sufficient, the system may stop processing B, and no time is lost, although there is an increased load on system B. If the predictor predicts corpus A, then only corpus A is searched. In some embodiments, if the predictor is wrong, then corpus B may then be searched in serial.

Embodiments of the present invention are independent of any ranking function, and do not rely on assumptions about the relevance of the search results, or assumptions about the person doing the searching.

In a purely serial architecture (employed by prior systems), all the query load is first sent to subsystem A. A fraction f of the query load is not answered well by subsystem A and is then sent to subsystem B.

Embodiments of the present invention employ a query broker, as represented by the merge box 116 in FIG. 1, that merges both result sets in negligible time. Thus, the average query time for the serial architecture is:

T_{S}=(1−f)t_{A}+f(t_{A}+t_{B})=t_{A}+ft_{B}

Embodiments of the present invention improve upon serial systems by predicting when a query will not be answered well by system A alone, and sending the query to both subsystems at the same time. This advantage is discussed below.

Any predictor has an accuracy associated with it, thus for any predictor, some subset of the queries will be predicted correctly. The degree to which average time is improved depends on the accuracy of the predictor. In the general case, suppose that the system predicts that a fraction of queries should be answered by system B. Some fraction, e_{FP}, of those queries are predicted incorrectly. On the other hand, the predictor may predict a fraction e_{FN} of queries to be answered by A that later had to be answered by B (in serial). Let f be the fraction of queries that should be sent to B. The average time is then:

T_{P}=(1−f)t_{A}+(f−e_{FN})t_{B}+e_{FN}(t_{A}+t_{B})=(1−f+e_{FN})t_{A}+ft_{B}

The coefficient of t_{A} includes all queries that just needed the first collection, while the coefficient of t_{B} includes all queries that needed the second collection. All these minus the queries that had to be processed in serial, which are accounted for in the coefficient of (t_{A}+t_{B}). T_{P} can be expressed as:

T_{P}=T_{S}−(f−e_{FN})t_{A}=T₀−αt_{A}

Hence, T_{P}≦T_{S}, and the degree to which it is reduced is dependent on the accuracy of the predictor, as reflected in the variable e_{FN}.

Recall e_{FN} is the fraction of queries answered by A and B in serial, and e_{FP} is the fraction of queries sent to B that are answered in time t_{A}. Let C_{B} be the infrastructure cost of the subsystems that serve corpus B. Recall that corpus A is always queried, so there is no additional cost associated with searching corpus A. The parallel architecture is faster if the prediction error is small, as shown above, but there is a trade-off because subsystem B receives a larger query load. The cost can be thought of in terms of the total number of queries that should have been sent to B, which is f, plus the additional queries that were erroneously sent to subsystem B. As an alternative, the total query load sent to B is f where e_{FN} of the query load is answered by system B after having been processed by system A. Thus the new infrastructure cost of the system, C_{B}, is

C′_{B}=(1+e_{FP}/f)C_{B}=βC_{B}

Then the overall additional cost also depends on the cost of system A, CA. That is ΔC_{B}=eFP/f(1+C_{A}/C_{B}). This is provided to illustrate that with the improved accuracy predictor of the present invention, infrastructure costs are slightly increased, but search results are served faster.

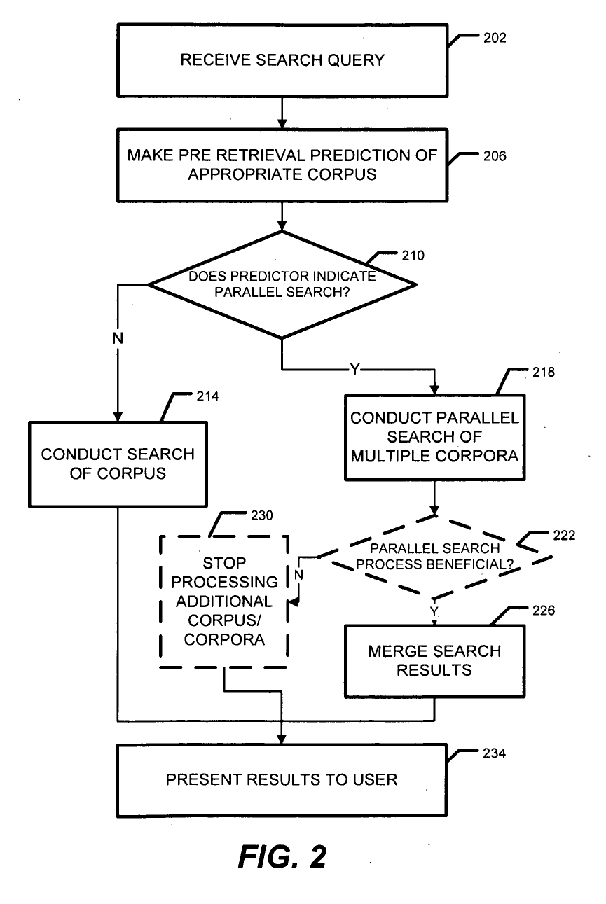

FIG. 2 is a flow chart depicting embodiments of a search process. Note that steps 222 and 230 are optional in different embodiments.

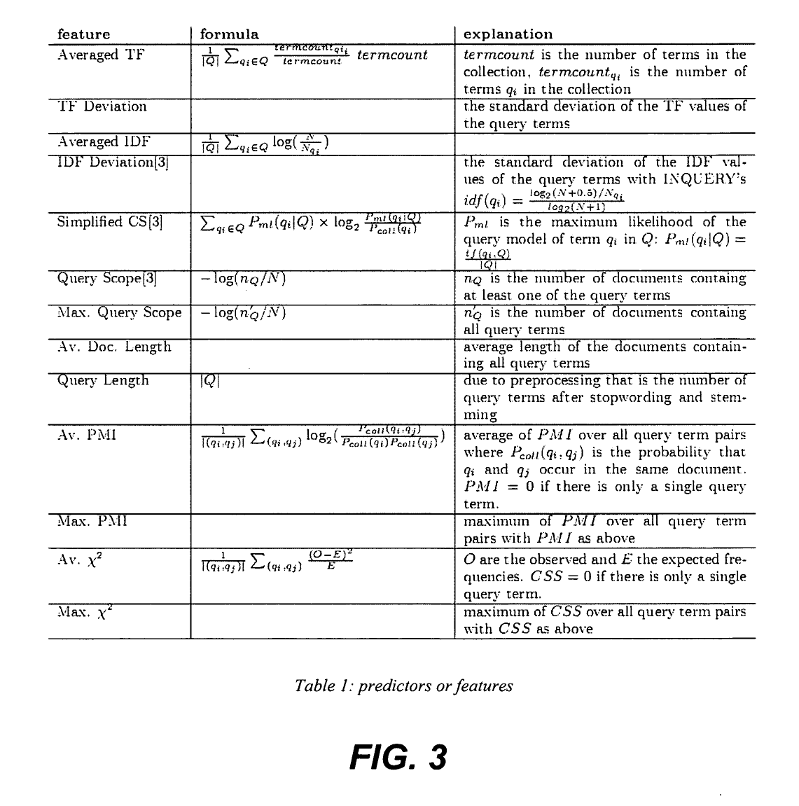

In step 202 the system receives a search query from a user. Next, in step 206, the system makes a pre-retrieval prediction of the appropriate corpus or corpora to search. This prediction involves a combination of a number of features or predictors shown in Table I and FIG. 3, and is discussed in greater detail in reference to FIG. 3 below. If, as seen in step 210 the predictor indicates the search is best served by searching at least two corpora in parallel, a parallel search is then conducted in step 218. In step 222, the system determines, during or after the process of parallel searching in step 218, whether the parallel search process is beneficial or necessary, as discussed above. If not, as seen in step 230, the system will stop searching the additional corpus/corpora or processing the search results, as seen in step 230. If, however, the parallel search process is deemed beneficial or necessary to provide sufficient results in step 222, the search results from the corpora will be merged in step 226. Finally, the search results are presented to the user in step 234.

If however, in step 210 the predictor indicates that the search is served sufficiently by searching a single corpus, the single corpus will be searched in step 214.

Pre-retrieval predictors do not rely on calculations of the top retrieved documents, but instead consider the query and the collection as a whole. Averaged IDF considers the average of the IDF values of all query terms. The advantage of this type of predictor is that there is no retrieval step necessary to determine if a query is good or bad (given the collection). However, since the prediction is retrieval independent, the influence of the retrieval algorithm is ignored. Search independent predictors can rely on the query, the collection, and external sources. Instead of using a single predictor, the system combines a number of simple predictors. Table I below, reproduced as FIG. 3, summarizes the features used.

TABLE 1
individual predictors/features

| feature | formula | explanation |
|---|---|---|
| Averaged TF | $\frac{1}{\vert Q \vert} {\sum }_{{q}_{i} ∈ Q} \frac{{termcount}_{{qi}_{i}}}{termcount} termcount$ | termcount is the number of terms in the collection, termcount_{q}_{ᵢ} is the number of terms qᵢ in the collection |
| TF Deviation | | the standard deviation of the TF values of the query terms |
| Averaged IDF | $\frac{1}{\vert Q \vert} {\sum }_{{q}_{i} ∈ Q} log ( \frac{N}{{N}_{{q}_{i}}} )$ | |
| IDF Deviation[3] | | the standard deviation of the IDF values of the query terms with INQUERY's $idf ( {q}_{i} ) = \frac{{log}_{2} ( N + 0.5 ) / {N}_{{q}_{i}}}{{log}_{2} ( N + 1 )}$ |
| Simplified CS[3] | ${\sum }_{{q}_{i} ∈ Q} {P}_{ml} ( {q}_{i} \vert Q ) \times {log}_{2} \frac{{P}_{ml} ( {q}_{i} \vert Q )}{{P}_{coll} ( {q}_{i} )}$ | Pₘₗ is the maximum likelihood of the query model of term qᵢ in Q: ${P}_{int} ( {q}_{i} \vert Q ) = \frac{tf ( {q}_{i} , Q )}{\vert Q \vert}$ |
| Query Scope[3] | -log (n_{Q}/N) | n_{Q} is the number of documents containg at least one of the query terms |
| Max. Query Scope | -log (n′_{Q}/N) | n′_{Q} is the number of documents containg all query terms |
| Av. Doc. Length | | average length of the documents containing all query terms |
| Query Length | \|Q\| | due to preprocessing that is the number of query terms after stopwording and stemming |
| Av. PMI | $\frac{1}{\vert ( {q}_{i} , {q}_{j} ) \vert} {\sum }_{( {q}_{i} , {q}_{j} )} {log}_{2} ( \frac{{P}_{coll} ( {q}_{i} , {q}_{j} )}{{P}_{coll} ( {q}_{i} ) {P}_{coll} ( {q}_{j} )} )$ | average of PMI over all query term pairs where P_{coll} (qᵢ, qⱼ) is the probability that qᵢ and qⱼ occur in the same document. PMI = 0 if there is only a single query term. |
| Max. PMI | | maximum of PMI over all query term pairs with PMI as above |
| Av. χ² | $\frac{1}{\vert ( {q}_{i} , {q}_{j} ) \vert} {\sum }_{( {q}_{i} , {q}_{j} )} \frac{{( O - E )}^{2}}{E}$ | O are the observed and E the expected frequencies. CSS = 0 if there is only a single query term. |
| Max. χ² | | maximum of CSS over all query term pairs with CSS as above |

In the table, a query Q is composed of individual query terms qᵢ, and a document D contains terms dᵢ. The total number of documents is N, and N_{qi} is the number of documents the query term qᵢ appears in. The term frequency tf(qᵢ,D) is the number of occurrences of term qᵢ in D, and P_{coll}(qᵢ) is the number of occurrences of qᵢ in the collection divided by the number of tokens in the collection. Some features take into account the relationship between query terms: Averaged Pointwise Mutual Information (PMI), Maximum PMI, Averaged Chi-Square (CSS) and Maximum CSS. As the features are calculated over pairs of query terms, their value is 0 in case of a single term query.

### Predictor Formulation Example and Efficacy

In order to determine which features would be better discriminators, the correlation with a corpus referred to as WT10G was used as a reference. The below table lists the linear correlation coefficients with respect to average precision of the TREC9 and TREC10 web tasks as well as the TREC10 entry page (ep) task. For further information regarding these tasks, please refer to: “Overview of the TREC-9 Web Track” by David Hawking published on Sep. 4, 2001 and available at http://trec.nist.gov/pubs/trec9/papers/web9.pdf; and “Overview of the TREC-2001 Web Track” by David Hawking and Nick Craswell published May 9, 2002 and available at http://trec.nist.gov/pubs/trec10/papers/web2001.ps.gz.

TABLE 2
Linear correlation coefficients

| feature | TREC9 | TREC10 | TREC10 ep |
|---|---|---|---|
| Averaged TF | −0.1806 | −0.0123 | −0.0173 |
| TF Deviation | −0.0396 | 0.2248 | −0.0203 |
| Averaged IDF | 0.1425 | 0.3259 | 0.0266 |
| IDF Deviation | 0.0665 | 0.2430 | 0.1586 |
| Simplified CS | 0.0813 | 0.3064 | 0.0491 |
| Query Scope | 0.0845 | 0.1253 | −0.0817 |
| Max. Query Scope | 0.2058 | 0.3225 | 0.3016 |
| Av. Doc. Length | 0.0565 | −0.0899 | 0.1687 |
| Av. PMI | 0.2914 | 0.1037 | 0.0526 |
| Max. PMI | 0.2606 | 0.3044 | 0.1394 |
| Av. χ² | −0.0921 | 0.0556 | −0.0291 |
| Max. χ² | −0.0685 | 0.0799 | 0.0127 |

Retrieval was performed with the language modeling approach to information retrieval. Dirichlet smoothing was applied and the best performing parameter setting in terms of mean average precision was used. The queries of the TREC 9 and 10 tasks were taken from query logs of a Web search engine, and therefore the results for TREC 9 and 10 are thought to be indicative of the results of the disclosed embodiments. Although none of the features correlates strongly by itself, together they produce classifiers that are significantly better than random (that is, more than 10% better), for both data sets.

For further information on the TREC9 and TREC10 web tasks as well as the TREC10 entry page (ep) task please refer to: E. Yom-Tov, D. Carmel, A. Darlow, D. Pelleg,

S. Errera-Yaakov, and S. Fine. Juru at TREC 2005: “Query prediction in the teraybyte and the robust tracks,” In TREC 2005, 2005 and E. Yom-Tov, S. Fine, D. Carmel, and A. Darlow “Learning to estimate query difficulty: including applications to missing content detection and distributed information retrieval,” In SIGIR 2005, pages 512-519, 2005.

Averaged IDF is similar to features proposed by K. L. Kwok in a paper entitled “an attempt to identify weakest and strongest queries' in Proceedings of the 28^{th} Annual Conference on Research and Development in Information Retrieval (SIGIR), 2005, which is hereby incorporated by reference in the entirety. Kwok et al. uses the average inverse document frequency over all query terms as predictor:

$$IDF ( {T}_{i} ) = log \frac{\vert C \vert}{DFi} .$$

where Tᵢ is a word, |C| is the number of documents in the collection, and DFᵢ is the document frequency of term i. A similar approach using a Simplified Clarity Score (CS) proposed by B. He and I. Ounis is entitled “Inferring query performance using pre-retrieval predictors,” In Proceedings of SPIRE, 2004, which is also incorporated by reference in the entirety. It relies on the term count of a term in the collection instead of its document frequency. He et al. evaluated a number of statistics that can be calculated at indexing time and thus do not rely on the retrieval. Apart from Simplified CS, the statistics include the standard deviation of the inverse document frequency of query terms, the query length and the query scope, which is defined as the number of documents in the collection that contain at least one of the query terms. The statistics include inverse document frequency of query terms, the query length, Simplified Clarity Score and the query scope, which is defined as the number of documents in the collection that contain at least one of the query terms. Embodiments utilize these features in the predictor, but rather than use them independently, they are used as features in a machine learned classifier.

For the predictor, a support vector machine (SVM) was utilized with 13 features computed over corpora A and B. Although any suitable SVM may be utilized, an implementation known as SVMlight⁵ with a radial basis kernel where γ=2 for a centralized system (corpus A and B collocated), and γ=0.005 for a distributed system (corpus A and B at different geographic locations. For further information on the SVM implementation and SVMlight please see T. Joachims' paper entitled “Text categorization with support vector machines: Learning with many relevant features,” in Proceedings of the European Conference on Machine Learning, 1998, and http://svmlight.joachims.org. While use of an SVM has been described, any machine learning technique may be utilized. For example, a decision tree or a perceptron may be employed.

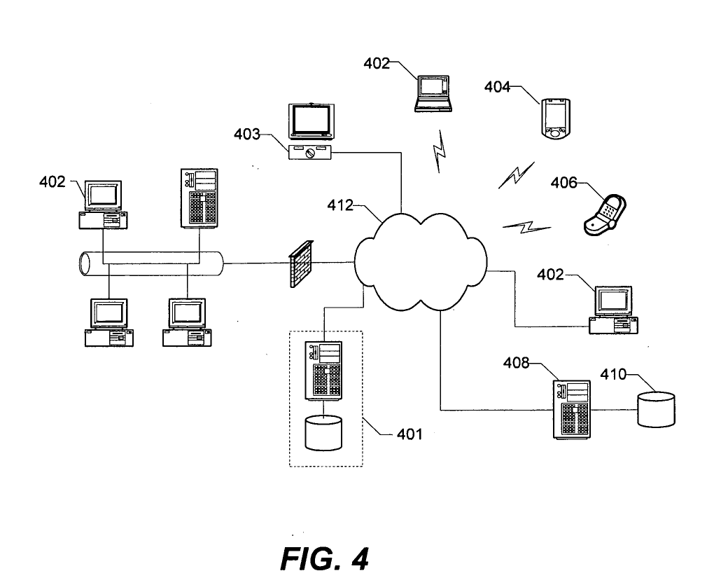

Searches in accordance with embodiments of the invention in a centralized or distributed manner. This is represented in FIG. 4 by server 408 and data store 410 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 412.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

### Example Results With a Centralized and Distributed System

For the centralized system, since the positive examples outnumbered the negative examples a cost on mispredicting the positive examples was set at 2 empirically with a held-out set. Table 3 shows the classification results. The better the pre-retrieval predictor, the more efficient the system is, but any predictor that is better than random will improve the system. The random prediction corresponds to the number of examples in the majority class. In the case of the centralized system, the majority of queries should be sent to both corpora.

TABLE 3
Centralized system classification accuracy for pre-retrieval predictors.

| | Random | Centralized |
|---|---|---|
| Classifier Accuracy | 0.714 ± 0.008 | 0.789 ± 0.009 |
| Precision | na | 0.772 |
| Recall | na | 0.998 |

TABLE 4
Retrieval results for the centralized system.

| | k = 50 | | | | |
|---|---|---|---|---|---|
| | 5 | 10 | 20 | 50 | 100 |
| Mean | 0.994 | 0.990 | 0.983 | 0.848 | 0.424 |
| St. Dev | 0.061 | 0.080 | 0.104 | 0.241 | 0.120 |
| | k = 100 | | | | |
| | 5 | 10 | 20 | 50 | 100 |
| Mean | 0.994 | 0.991 | 0.985 | 0.925 | 0.812 |
| St. Dev | 0.060 | 0.081 | 0.102 | 0.170 | 0.082 |

The results are statistically significant using a t-test at the p<0.01 level, using 10-fold cross validation, where the training set was 90% of the data, and the test set was 10% of the data.

For each query, the pre-retrieval classification determined whether the query was served by collection A or collections A and B. In either case, the results from collection A were verified against an oracle, and if they were sufficient, the results from A were presented. Otherwise the results from B were presented. Table 4 shows the final results of the system, in terms of Pₖ(N) where k={50. 100} and N={5, 10, 20, 50, 100}. The results at the top of the ranked list are indistinguishable for both systems, which is exactly what we would want in a real system. Further down in the ranked list, the results vary to a greater degree from query to query. The results below rank 50 no longer overlap between the two systems.

In this case we have f=0.714, e_{FP}=0.210 and e_{FN}=0.001. Then, the cost of the centralized system is:

$${T}_{S} = {t}_{A} + 0.714 {t}_{B}$$

$${T}_{P} = {T}_{S} - 0.494 {t}_{A}$$

$$Δ T = \frac{0.494}{1 + 0.714 {t}_{B} / {t}_{A}}$$

$$Δ C = \frac{0.294}{1 + {C}_{A} / {C}_{B}}$$

This implies that if for example the time to process a query in system B is twice the time to process a query in system A, and because B is a larger system, carries twice the cost, then the system is 24% faster, but at the same time 20% more expensive due to the load on B. Replacing these values in the conditions of equation 6, we have that the trade-off is worth it if β>0.295 (it is 0.429) and e_{FN}<0.487, which is also true.

The distributed system had approximately ten times the number of documents that the centralized system had (Table 1). The vocabulary for the distributed system was approximately four times the size of the centralized system. However, inspite of the fact that the distributed system includes documents in two languages, the proportion of the vocabulary of corpus A to corpus B in the distributed system is 0.41.

TABLE 5
Distributed system classification accuracy for pre-retrieval predictors.

| | Random | Centralized |
|---|---|---|
| Classifier Accuracy | 0.539 ± 0.006 | 0.776 ± 0.006 |
| Precision | n/a | 0.987 |
| Recall | n/a | 0.592 |

TABLE 6
Retrieval results for the distributed system.

| | k = 50 | | | | |
|---|---|---|---|---|---|
| | 5 | 10 | 20 | 50 | 100 |
| Mean | 0.994 | 0.990 | 0.982 | 0.912 | 0.470 |
| St. Dev | 0.061 | 0.082 | 0.104 | 0.156 | 0.072 |
| | k = 100 | | | | |
| | 5 | 10 | 20 | 50 | 100 |
| Mean | 0.994 | 0.991 | 0.985 | 0.969 | 0.868 |
| St. Dev | 0.060 | 0.082 | 0.103 | 0.136 | 0.187 |

The similarity in proportion to the centralized system is somewhat surprising as you would expect a system representing two languages to have roughly twice the vocabulary size. It is important to remember that not all documents and queries in the Spanish collection are in Spanish.

For the distributed system, the positive examples made up nearly 50% of the data, so there was no need to adjust the cost of misclassification. The classification results are given in Table 5. The results are statistically significant using a t-test at the p<0.01 level, using 10-fold cross validation, where the training set was 90% of the data, and the test set was 10% of the data.

The retrieval performance for the distributed system is shown in Table 6. As with the centralized case, the top of the ranked list is indistinguishable between corpus A and corpus B, and the results after rank 50 do not degrade as quickly for the distributed system as for the centralized. This is an artifact of the number of positive examples in the data, however as the queries for the distributed system were sampled randomly from a real-world query log, this case represents a more realistic view of the system. The load on the infrastructure that handles corpus B is higher, but in general the system performs more efficiently. This is not surprising as the pre-retrieval classifier for the distributed system is more accurate. In this case we have f=0.539, e_{FP}=0.004 and e_{FN}=0.220, so:

$${T}_{S} = {t}_{A} + 0.539 {t}_{B}$$

$${T}_{P} = {T}_{S} - 0.319 {t}_{A}$$

$$Δ T = \frac{0.319}{1 + 0.539 {t}_{B} / {t}_{A}}$$

$$Δ C = \frac{0.007}{1 + CA / {C}_{B}}$$

Using the same example as in the centralized system (t_{A}=t_{B}/2 and C_{B}=2C_{A}), the distributed system is 11% faster with 0.5% additional cost. However, a more realistic answer time relation, as we are contacting a remote system, would be t_{A}=t_{B}/5. In that case the time improvement is only 5%, but still with a negligible cost increase. Replacing these values in the conditions of equation 6, we have that the trade-off is worth it if β>0.013 (it is 0.436) and e_{FN}<0.532, which is also true.

The above described embodiments have several advantages and are distinct from prior methods. Even modest achievements in pre-retrieval classification are sufficient to improve the efficiency of the system. This gain in efficiency and accuracy can be achieved without introducing added delay to the search process, as the features used in the classification can be calculated off-line, and thus do not affect the performance of the system as a whole. Once the classifier has been learned, the time to classify the query is negligible.

While the invention has been particularly shown and described with reference to specific embodiments thereof, it will be understood by those skilled in the art that changes in the form and details of the disclosed embodiments may be made without departing from the spirit or scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for providing search results, comprising:
providing a first corpus of searchable information;
providing a second corpus of searchable information;
receiving a search query;
performing a pre-retrieval prediction of the search query to determine whether the query is best handled by the searching the first corpus alone or by searching the first and second corpus in parallel,
the pre-retrieval prediction comprising combining at least two search independent predictors in formulating the prediction.

2. The method of claim 1, wherein the at least two combined search independent predictors are from a group of predictors comprising: average pointwise mutual information; maximum pointwise mutual information; averaged Chi-square; maximum Chi square; averaged term frequency; term frequency standard deviation; averaged IDF; IDF deviation; simplified CS; query scope; maximum query scope; average document length; and query length.

3. The method of claim 1, wherein performing the pre-retrieval prediction further comprises using a support vector machine to determine a hyperplane between information of the first corpus and information of the second corpus.

4. The method of claim 1, further comprising, if so indicated by the prediction, searching the first and second corpus in parallel.

5. The method of claim 1, further comprising, if so indicated by the prediction, searching only the first corpus.

6. The method of claim 4, further comprising merging the search results from the first and second corpus.

7. The method of claim 1, wherein the first corpus is primarily in a first language and the second corpus is primarily in a second language.

8. A computer system for providing search results to users, comprising;
a first corpus of searchable information at a first computer storage medium;
a second corpus of searchable information at a second computer storage medium;
a computer processor configured to make a pre-retrieval prediction of whether the query is best handled by searching the first corpus alone or by searching the first and second corpus in parallel,
the pre-retrieval prediction comprising combining at least two search independent predictors in formulating the prediction, the predictors selected from the group comprising: average pointwise mutual information; maximum pointwise mutual information; averaged Chi-square; maximum Chi square; averaged term frequency; term frequency standard deviation; averaged IDF; IDF deviation; simplified CS; query scope; maximum query scope; average document length; and query length.

9. The system of claim 8, further comprising one or more computers configured to utilize a support vector machine to determine a hyperplane between information of the first corpus and information of the second corpus.

10. The system of claim 9, wherein the computer processor is configured to make the pre-retrieval prediction by accessing analysis of the support vector machine.

11. The system of claim 8, wherein a processor of the system is configured to access the prediction and search the first and second corpus in parallel if so indicated by the prediction.

12. The system of claim 8, wherein a processor of the system is configured to access the prediction and search only the first corpus.

13. The system of claim 8, wherein a processor of the system is configured to merge the search results from the first and second corpus.

14. The system of claim 8, wherein the first corpus is primarily in a first language and the second corpus is primarily in a second language.

15. A computer-implemented method for formulating search results, comprising:
providing a first corpus of searchable information;
providing a second corpus of searchable information;
combining a plurality of predictors selected from the group comprising:
average pointwise mutual information;
maximum pointwise mutual information;
averaged Chi-square;
maximum Chi square;
averaged term frequency;
term frequency standard deviation;
averaged IDF; IDF deviation;
simplified CS;
query scope;
maximum query scope;
average document length; and
query length;
predicting, in advance of a search request and based upon the combination of predictors, whether the request (i) is best fulfilled by searching only the first corpus, or (ii) is best fulfilled by searching the first and second corpus in parallel; and
receiving a search query.

16. The method of claim 15, wherein predicting further comprises using a support vector machine to determine a hyperplane between information of the first corpus and information of the second corpus.

17. The method of claim 15, further comprising, if so indicated by the prediction, searching the first and second corpus in parallel.

18. The method of claim 15, further comprising, if so indicated by the prediction, searching only the first corpus.

19. The method of claim 17, further comprising merging the search results from the first and second corpus.

20. The method of claim 17, wherein the first corpus is primarily in a first language and the second corpus is primarily in a second language.
